(19) United States
(12) Patent Application Publication
(10) Pub. No.: US 2009/0254411 A1
(43) Pub. Date: Oct. 8, 2009

(54) SYSTEM AND METHOD FOR AUTOMATED DECISION SUPPORT FOR SERVICE TRANSITION MANAGEMENT

(76) Inventors: Kamal Bhattacharya, Pleasantville, NY (US); Heiko Ludwig, San Francisco, CA (US); Thomas Setzer, Munchen (DE)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/062,646

(22) Filed: Apr. 4, 2008

(51) Int. Cl. G06Q 90/00

(52) U.S. Cl. 705/10

(57) ABSTRACT

A system and method for determining and managing risk impact of service downtime includes defining a process structure of one or more process types, services the process structure employs and a distribution of the services' time durations. Process usage data is collected for each type of process, and risk is estimated based on penalties and expected deadlines for each process. For a service change and outage of a given length of time, an optimal change window is determined with respect to a minimized impact on the process based on the estimated risk.

### BACKGROUND

1. Technical Field

The present invention relates to risk management and more particularly to systems and methods for managing operational risks of service downtime in accordance with their impact.

2. Description of the Related Art

In recent years, information technology (IT) service management (ITSM) has received much attention as enterprises understand that operating their IT infrastructure is a large part of their overall operating costs. Today's businesses operate in dynamic environments with the need to continuously adapt to changing customer expectations, market trends, technical enhancements or changes to legislation. These changes entail changes to IT services and business processes to drive alignment of IT with business requirements. Uncontrolled changes including flawed risk and impact analysis cause a majority of business-critical service disruptions.

Publicly available best-practices IT Service Management (ITSM) frameworks such as the IT infrastructure Library (ITIL) define reference change management processes including several activities like change initiation, where a Request for Change (RFC) describing the required change is submitted, change filtered, priority allocated, categorized, planned, tested, fulfilled and reviewed. Major changes must be analyzed and approved, from a technical as well as from a business point of view before the changes get scheduled.

As modern IT service infrastructures are continuously transformed towards virtualized resource pools and Service-Oriented Architectures (SOA), applications and infrastructure resources can be viewed as services shared in a larger value network and invoked in the context of various business processes. Services can be described using standards such as WSDL and invoked via a suitable Internet protocol.

Considering the number of business processes in an enterprise and the complexity of the dependency network of processes to invoked services, changes in this kind of environment may pose significant risks due to the multitude of interdependencies and uncertainties to manage, and the impact of failures is likely to be business-critical as many business processes might depend on this service. Therefore, efficient and reliable change management aiming at continuous service delivery by automatically considering the dependency chains is essential.

Consider the following example, illustrated in FIG. 1. A business process application 20 runs several CRM (customer relationship management) processes, from Lead Generation to Sales Order Generation. The application 20 itself is hosted on one or more physical resources and has dependencies to other applications (or services) and infrastructural components. Estimating the impact of an application failure is—without detailed knowledge of the dependency chains—a fairly manageable problem. Application A 22 is connected to Application B 24. Downtime of Application B means an impact on Application A. This view however is not sufficient as an organization managing the business process Application A will alert business users that the CRM application will be unavailable, which could for example lead to unfulfilled sales orders. The right pictorial 30 illustrates the more realistic scenario, where Application A 32 is hosting two processes 10 and 12, e.g., Lead Generation and Sales Order Generation. The actual downtime of Application B 34 may only lead to unavailability of Lead Generation but not Sales Order Generation (which in the CRM context is a much lower risk). Furthermore, based on the fact that the affected Lead Generation may be a long-running business process, one can imagine that only a subset of all running instances will be affected depending on the state of each instance. The longer the duration of downtime for a given service or application or network resource that is used by a business process, the more likely it is to experience business value attrition due to service level agreements (SLA) violations and associated penalties.

How many instances of a particular process are affected highly depends on the business process demand while fulfilling the change. Process demand, however, is generally not known a-priori but has to be approximated by means of forecasting techniques.

### SUMMARY

In accordance with the present principles, we focus on of determining and minimizing change related risk in Service-Oriented Business environments as illustrated above by introducing decisions models allowing organizations for scheduling service changes with a lowest expected financial loss, or cost. We believe that change scheduling should minimize the risk of downtime for business value generating services. We provide models for analyzing the business impact of change related service downtimes of uncertain length, as the impact on dependent, active business processes is analyzed and transferred into financial losses. One solution automatically considers the dependency chain from a business process down to affected resources, applications or other services realized by business processes. Based on these analytical models, we derive decision models in terms of deterministic and probabilistic mathematical programming formulations allowing for scheduling single or multiple correlated changes efficiently.

The present embodiments serve to fill the gap in work addressing the formal quantification of service change risk to active and depending business processes, enabling the scheduling of service changes with minimum total expected costs.

A system and method for determining and managing risk impact of service downtime includes defining a process structure of one or more process types, services the process structure employs and a distribution of the services' time durations. Process usage data is collected for each type of process, and risk is estimated based on penalties and expected deadlines for each process. For a service change and outage of a given length of time, an optimal change window is determined with respect to a minimized impact on the process based on the estimated risk.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram comparing two scenarios for describing a need in the art;

FIG. 2 is a diagram showing a multi-layered dependency model in accordance with one illustrative embodiment;

FIG. 3 is a diagram showing a dependency model for handling a non-linear process and service flows in accordance with one embodiment;

FIG. 4 is a plot showing downtime probabilistic modeling in accordance with a stochastic risk estimation model, transforming a continuous probabilistic function into a set of aggregated probability values in discrete time intervals;

FIG. 5 is a display image of an analyzed service infrastructure scenario in an experimental simulation tool for carrying out the present principles;

FIG. 6 is a plot of an example business process demand scenario;

FIG. 7 is a bar chart showing aggregated experimental results;

FIG. 8 is a block/flow diagram showing a system/method for automated decision support for service transition management in accordance with the present principles; and

FIG. 9 is a block diagram showing a system for automated decision support for service transition management in accordance with the present principles.

### DETAILED DESCRIPTION OF PREFERRED EMBODIMENTS

In accordance with the present principles, models for analyzing business impact of operational risks resulting from change related service downtimes of uncertain duration are provided. One solution takes into account the network of dependencies between services where services may or may not be realized through business processes. Based on the analytical model, we derive decision models in terms of deterministic and probabilistic mathematical programming formulations to schedule single or multiple correlated changes efficiently. Preliminary experiments are described to illustrate the efficiency of the models. Using these decision models, organizations can schedule service changes with the lowest expected impact on the business.

In IT service delivery, alignment of service infrastructures to continuously changing business requirements is a primary cost driver, as most severe service disruptions can be attributed to poor change impact and risk assessment. We distinguish between different types of services. An atomic service in our definition is a service with a well-defined transaction boundary that provides a simple single operation (e.g., generate IP or assignServerName). A business process executes by invoking atomic services, other services that may be composed of atomic services (e.g. short running automated workflows) or other business processes. Each service is executed on an IT resource. In principle, we can consider an IT resource as a service as well.

An IT service, defined as a means to provide value to a consumer, may be realized by a network of shared application and other resources that are invoked in the context of business processes. In the spirit of Service-Oriented Architecture (SOA) we consider each application or resource as a service. Changing services or service definitions in such an environment includes exceptionally high risk and complexity, as various business processes might depend on a service.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Service transitions and associated risk on Business processes: The goal of service transition management is to plan and control service changes and deploy changed service releases into a production environment successfully, i.e., with minimum negative impact to the business. We assume that a service is down during the change fulfillment period. Service transition in Service-Oriented Architectures is coupled with exceptionally high risk and complexity, as there are multiple interdependencies und uncertainties, and many business processes might depend on a service. To estimate the risk of services changes to the business (processes), a clear picture and a formal description of the business process and service dependency structure is needed.

We will now introduce a notation that is used throughout this disclosure to formalize process and service dependencies. Let I be the total number of different types of business processes i (i=1, . . . , I) requested stochastically following a demand distribution or profile Dᵢ. In other words, there are I different business process definitions existing, instantiated on request. A second layer service definition j (j=1, . . . , J) describes an aggregated or composite service on the layer below the business process layer (i.e., the first layer). This layer represents typically automated workflows that merely string together several atomic services. Furthermore, an assignment variable uᵢⱼ indicates that a business process i implements service j in step uᵢⱼ. Steps of a business process i are enumerated by nᵢ (nᵢ=1, . . . Nⱼ). We set uᵢⱼ=0 if a business process i definition does not implement service j. In the same manner, we model the dependencies of lower-level services. We enumerate the service descriptions on the next lower aggregation level by k (k=1, . . . , K) and assign these third-level services by setting uⱼₖ correspondingly to the step nⱼ (nⱼ=1, . . . Nⱼ) in the j service flow definition. Likewise, we set uⱼₖ=0 if k is not implemented by j.

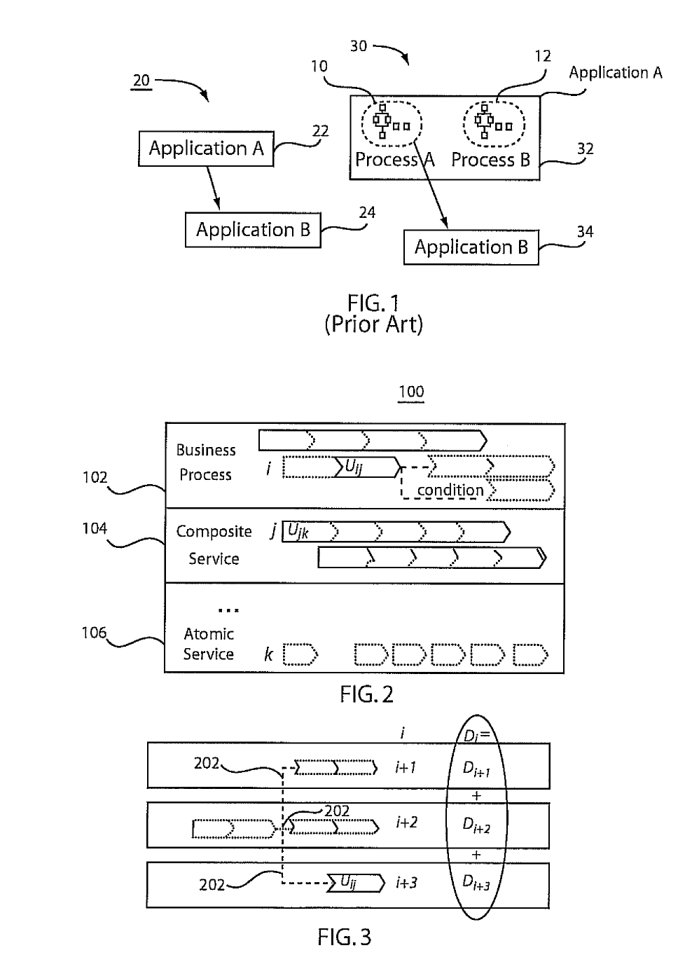

Referring now to the drawings in which like numerals represent the same or similar elements and initially to FIG. 2, a three layer service dependency model 100 is illustratively shown for a resulting dependency structure. Using this dependency model 100, one can automatically derive which higher-level services and business processes are affected by a specific service downtime. Model 100 may include business processes 102, composite services 104, which are comprised of atomic services 106.

However, to estimate the business impact of a change, additional information is needed, e.g., how many instances of business processes are affected, and how many service level agreements (SLA) of these processes are expected to be violated. The amount of affected business process instances depends on the business process demand at and before the time a change is fulfilled. Business forecasting techniques are used to estimate the demand for a certain business process during a particular period of time. With Dᵢ as a business process i's demand distribution profile (i.e., the demand distributions profile of all considered time slots t, Dᵢₜ, demand forecasts dᵢₜ are possible for a certain time slot t (for example by setting dᵢₜ to Dᵢₜ's mean value).

For the sake of computational efficiency, we divide time into small discrete time slots, wherein we assume a fixed level demand profile. Costs of business process disruptions or delays are defined in SLAs. A SLA typically includes a process' maximum response or execution time Lᵢ and the definition of (monetary) penalties pᵢ to pay on SLA violations. Depending on a SLA, penalties are paid per maximum response time violation, if the number of service level violations during a given time span exceeds a defined threshold value, or other individual agreements.

Simply multiplying the number of process instances expected during the duration of a change with the penalties would overestimate change related costs, as not all running business process instances will be disrupted or delayed. For example, business process instances which already passed the step implementing the service that is going to be changed will not be affected at all, nor is there an impact on running processes instances which will execute the changed service after the change is fulfilled and the service is again available. Furthermore, business processes and services might be queued. If the time buffer, i.e., the difference between the maximum execution time and the normal or usual execution time is large enough, there is a chance to still execute affected processes instances in a SLA compliant way.

In the following, a procedure is described to estimate the amount of SLA violations if queuing is not possible. Furthermore, we extend this by including queuing processes and services. We start out with a deterministic model by assuming complete knowledge of process demand per time slot and change related downtime followed by introducing a probabilistic model to account for uncertainty in both demand and service downtime.

SLA violations without queuing: Consider a request for change (RFC) for service j, where j will be unavailable for a duration Δtⱼ^{down} after the change start time tⱼ. The task is to estimate dᵢⱼₜ^{p}, the number of SLA violations of dependent business process instances. Given this number for each affected business process, the estimated costs of changing j in t, cⱼₜ are:

$${c}_{jt} = {\sum }_{i} {p}_{i} {d}_{ijt}^{p} \qquad ( 1 )$$

To predict dᵢⱼₜ^{p} we proceed as follows: all service instances executing j during time period [tⱼ; tⱼ₊Δtⱼ^{down}] are disrupted. From a planning perspective, we assume equal arrival rates of business process requests (principle of indifference) as there is only aggregated knowledge of service demand per time slot available. This assumption is tight as long as the forecasting time periods are kept small. Of interest is the demand for a business process i not only during the change downtime Δtⱼ^{down} but also before tⱼ, as running process instances starting before tⱼ might reach j during [tⱼ, tⱼ₊Δtⱼ^{down}]. Depending on the step in which a business process i implements service j, business process instances starting after tⱼ−Lᵢ might be affected if j is executed in the last process step (uᵢⱼ=Nᵢ). If j is executed in the next to last step (uᵢⱼ=Nᵢ−1), only process instances starting after tⱼ−Lᵢ+L_{N(i)} are affected, etc.

On the other side, if i implements j in step Nᵢ, and the total execution duration of preceding process steps exceeds j's downtime, instances starting during [tⱼ, tⱼ₊Δtⱼ^{down}] are not affected by the current change. To approximate the demand for a business processes i with j execution overlapping with [tⱼ, tⱼ₊Δtⱼ^{down}], dᵢⱼₜ^{p}, we therefore consider business processes demand during:

$$[ {t}_{j} - {L}_{i} + {\sum }_{{j}^{′}} {L}_{j}^{′} ; {t}_{j} + Δ {t}_{j}^{down} - {\sum }_{{j}^{″}} {L}_{j}^{″} ] \qquad ( 2 )$$

where j′ is a service executed in a process i steps preceding j's implementation step and j″ is a service executed in a step after j's implementation step.

An alternative, more coarse-grained way of approximating dᵢⱼₜ^{p}, with no further knowledge of the concrete step, a process i implements a service j is described in the following: assuming an equal demand distribution around tⱼ, the percentage of i business process instances executing j during in [tⱼ, tⱼ₊Δtⱼ^{down}] is

$$( on average ) \frac{{L}_{j}}{{L}_{i}} \qquad ( 3 )$$

where Lⱼ is the execution duration of j, and Lᵢ is the overall process execution duration. The probability that a running process instance (executing a step preceding uᵢⱼ) will reach j in [t_{;}, tⱼ₊Δtⱼ^{down}] is

$$\frac{Δ {t}_{j}^{down}}{{L}_{i}} . \qquad ( 4 )$$

Therewith, the expected total costs of SLA violations caused by changing j in tⱼ are

$${c}_{ji} = {\sum }_{i \text{:} {u}_{ij} > 0} ( ( \frac{Δ {t}_{j}^{down} + {L}_{j}}{{L}_{i}} ) {d}_{Ijt} Δ {t}_{j}^{down} ) {p}_{i} . \qquad ( 5 )$$

SLA violations with queuing: We will now look at the estimated costs of changing j in time slot t if queuing (or buffering) is allowed. Here, not all business process instances executing j overlapping with [t_{j;} tⱼ₊Δtⱼ^{down}] are disrupted, as instances can re-execute j after the change is fulfilled. If a SLA is violated depends on a process' time buffer bᵢ (bᵢ=L_{i,max-L}ᵢ), where L_{i,max} is the maximum execution time of a process, and Lᵢ is the normal or usual execution time of a process. Again, the probability of a process instance currently executing j is shown in equation (3). If bᵢ≦Δtⱼ^{down}, all considered process i instances will exceed the maximum response time. If bᵢ>Δtⱼ^{down}+Lⱼ, no service instance is disrupted. If Δtⱼ^{down}<bᵢ<Δtⱼ^{down}+Lⱼ, there is a chance of a rollback and re-execution without SLA violation if the time buffer exceeds the amount of time already spend executing j before tⱼ plus j's downtime Δtⱼ^{down}. This probability is shown in equation (6) as:

$$( \frac{{L}_{j}}{{L}_{i}} ) ( 1 - \frac{{b}_{i}}{{L}_{i}} ) . \qquad ( 6 )$$

The probability that a running process instance (executing preceding steps) will reach j in [t_{j;} tⱼ₊Δtⱼ^{down}] is shown in Eq. (4). If bᵢ>Δtⱼ^{down}, all services are delivered successfully. If bᵢ<Δtⱼ^{down}, the average rate of successful delivered business process instances is

$$( \frac{Δ {t}_{j}^{down}}{{L}_{i}} ) ( \frac{{b}_{i}}{Δ {t}_{j}^{down}} ) . \qquad ( 7 )$$

Non-Linear Business Processes and Service Flows: The estimation of change related penalties as introduced above assumes linear business processes and service flows with a predetermined sequence of service executions. In practice, business processes might take different branches or service flow paths based on certain conditions. One branch might include a service to be changed while others do not. Hence, business process forecasting ignoring such conditional branches overestimates the number of SLA violations and costs. A finer-grained demand forecast is needed for each possible branch. This forecast can be derived by analyzing the history of the different executed branches in the same way the total demand for linear processes is derived by business forecasting methods. We model each branch as its own business process as shown in FIG. 3.

Referring to FIG. 3, an illustration depicts the modeling of a plurality of conditional branches 202, each as its own business process. Using this statistical means, one can model forked business processes. Processes including iterative sequences like loops can be demodulated in the same manner, by defining each possible flow as its own process and by assigning probabilities (Dᵢ) derived from statistical analyses of log data.

Change scheduling decision models: We will first introduce a basic change scheduling decision model for shared services underlying a number of restrictive assumptions like perfect knowledge of business process demand per time slot and deterministic change related downtimes of services. Afterwards, we will provide model variants considering uncertainty in business process demand and stochastic service downtime. Based on these model formulations, extensions are introduced to consider other types of operational risks and costs associated with service transitions. Furthermore, we address the problem of handling correlated changes.

Basic Deterministic Model: We will now introduce a deterministic mathematical programming model (DMP) to solve the problem of finding the schedule for a set of uncorrelated changes J_{RFC} with minimum overall service level violation costs in environment without queuing. Business process demand per time slot t, dᵢₜ, the downtime of a service after the change start time, Δtⱼ^{down}, and execution durations of services, Lⱼ, are approximated by using their mean values. A penalty is paid per SLA violation.

We introduce a binary decision variable x_{j,t}ε{0,1} indicating whether j's change is started in tⱼ or not. Objective functions to minimize the total sum of penalties resulting from changes in service infrastructures without queuing may include:

$$min {\sum }_{j ∈ {J}_{RFC}} {\sum }_{i : {u}_{ij} > 0} {\sum }_{t} ( ( \frac{Δ {t}_{j}^{down} + {L}_{j}}{{L}_{i}} ) {d}_{ijt} Δ {t}_{j}^{down} ) {p}_{i} {x}_{j , t} . \qquad ( 8 )$$

Non-Linear Business Processes and Service Flows: We set the beginning of our change planning period to t=0 and assume to obtain J_{RFC} before t=0 (Note that in practice, changes will be requested on a continuous time base rather than bundled). The usual way to proceed is to re-calculate the optimization problem each time a new RFC is submitted. More advanced methods might forecast aggregated RFC ‘demand’ if changes are submitted in regular sequences. As we divide time into discrete time slots, time related parameters are of positive integer type (tⱼ, Δtⱼ^{down}, bᵢ, Lᵢ, LⱼεZ₀⁺) and penalties and demand parameters are of positive real type (dᵢₜ, pᵢεR₀⁺).

As further constraints, we introduce change related deadlines tⱼ^{d}. Depending on the severity of a change, there is generally a priority associated with a change, defining a deadline when a change needs to be implemented. This constraint can be formulated as:

$${\sum }_{{t}_{j} + Δ {t}_{j}^{down} < {t}_{j}^{: 1}} {x}_{j , t} = 1 , ∀ j ∈ {J}_{RFC} . \qquad ( 9 )$$

Note that a change deadline is originally defined as a period Δtⱼ^{d} after tⱼ^{RFC}, the time the RFC for j arrives. As we define tⱼ,^{RFC}=0, setting the deadline to tⱼ^{d} instead of tⱼ^{RFC}+Δtⱼ^{d} suffices in this case.

Stochastic Change Scheduling Model: We have used deterministic approximations for expected demand, service downtime and service execution durations. Ignoring the probabilistic nature of demand, it should be expected that downtime and execution time have a negative impact on decision making. Suppose a service j change, and a depending business process i with extremely high penalties to pay on service level violations are considered. The average change related downtime of j is 10 but varies broadly, and the decision is either to start the change in t=0 or in t=50. The demand for i is expected to be slightly lower during t=0−9 than during t=50−59 but increases rapidly from t=10 on, while demand is expected to be of constant level after t=59. The deterministic model would certainly select t=0 while a stochastic model explicitly taking into account uncertainty of downtime would select t=50, which would be the better decision.

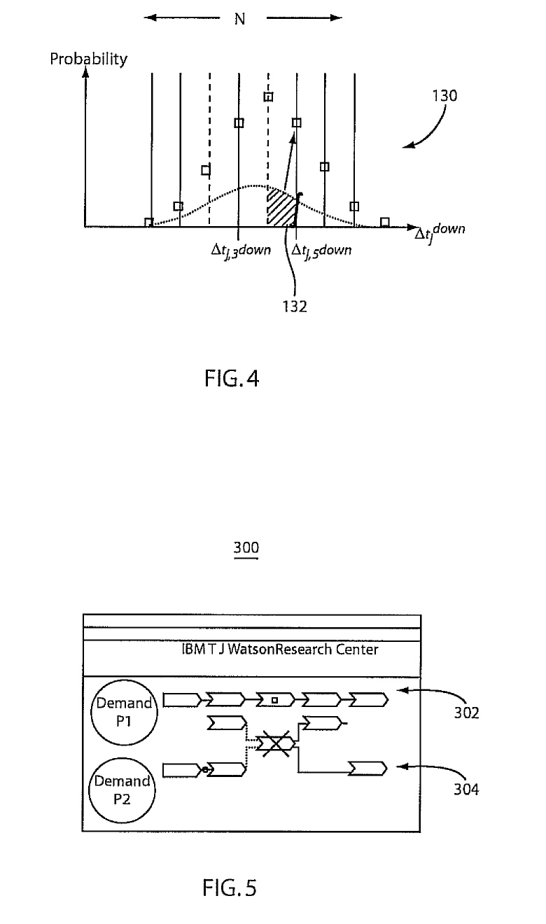

However, putting too much stochastic information into a decision model makes it—at least for medium and large problem sizes—intractable due to the large number of resulting decision variables and limits therefore its practical applicability. Therefore, we draw on a stochastic programming formulation with simple recourse as introduced for example by de Boer and Birge to consider the stochastic nature of the variables while keeping the model computable (See S. V. de Boer, R. Freling, N. Piersma, “Stochastic Programming for Multiple-Leg Network Revenue Management” Report EI-9935/A , ORTEC Consultants, Gouda, Netherlands, 1999; and J. R. Birge, F. Louveaux, “Introduction to Stochastic Programming,” Springer Series in Operations Research, 1997, both incorporated by reference). This is illustrated using a change related downtime probability distribution as depicted in FIG. 4.

Referring to FIG. 4, a probabilistic downtime model 130 is illustratively shown. In the model, we separate the distribution into N sequential discrete sections n (n=1, . . . , N). A cumulated probability (integral) 132 of a section is then interpreted as the downtime probability of one dedicated time slot in the section, while we suppose the downtime can only take these discrete downtime values: Δtⱼ^{down}ε{Δt_{j,1}^{down}Δt_{j,2}^{down}, . . . , Δt_{j,N}^{down}}. The resulting objective function can be formulated as:

$$min {\sum }_{j ∈ {J}_{RFC}} {\sum }_{i : {u}_{ij} > 0} {\sum }_{i} {\sum }_{n = 1}^{N} P ( Δ {t}_{j , n}^{down} ) ( \frac{Δ {t}_{j , n}^{down} + {L}_{j}}{{L}_{i}} ) {d}_{ijt} Δ {t}_{j , n}^{down} {p}_{i} {x}_{j , t} . \qquad ( 10 )$$

The right part of the objective function computes the costs that would result if the downtime would have been exactly Δt_{j,n}^{down}; the term on the left is a correction for the uncertainty in downtime (a weight). Likewise, we model the other stochastic variables, like business process demand, during a time slot or the execution time of a service. The parameters or even the type of distributions will depend on which time slot is considered.

Change Fulfillment Deadlines and Waiting Costs: As mentioned, a change needs to be fulfilled in a maximum change fulfillment time Δtⱼ^{d} after a change request is submitted. The urgency depends on the priority of a change. In the basic deterministic model formulation, we assumed that this deadline is mandatory. Considering the uncertainty in the time needed to perform the service change (we assume the service to be down during change activities), it can no longer be guaranteed to fulfill a change before the agreed change deadline; only a probability can be assigned to fulfilling the change in time. Therefore, the restriction that a change needs to be fulfilled before tⱼ^{d} of the change deadline needs to be relaxed to:

$${\sum }_{i} {x}_{j , i} = 1 , ∀ j ∈ {J}_{RFC} . \qquad ( 11 )$$

Exceeding a change deadline may entail a predefined penalty and extra payments for each additional time slot needed to fulfill the change. The later a change is started, the higher the expected costs of a deadline violation will be, since the probability of completing change implementations before their deadline will decrease continuously. Let the fixed penalty on change deadline violation be α, and the additional costs per time slot a deadline is exceeding be β. Therewith, the expected overall deadline violation cost function which needs to be added to the objective function as formulated in the present decision model is:

$$min {\sum }_{t} ( α ( {t}_{j} + Δ {t}_{j}^{down} - {t}_{j}^{d} ) > 0 ) + β ( max ( 0 , {t}_{j} + Δ {t}_{j}^{down} - {t}_{j}^{d} ) ) ) {x}_{jt} . \qquad ( 12 )$$

For brevity, we provide equations with only the service downtime modeled stochastically while other stochastic parameters are approximated by their mean values. Furthermore, the moment an RFC is submitted, there may already be a need felt for the change to be implemented as the business may suffer until the change has been fulfilled; for example, this may be due to a service being unavailable as would happen if the change request was initiated as a result of an incident, or there may be other negative impact causes, like, e.g., lost opportunities such as would occur for a change meant to bring up a newly needed service. With γ as the implicit costs of waiting one more timeslot for a change to be fulfilled, the waiting costs can be formulated as;

$${\sum }_{t} γ ( {t}_{j} + Δ {t}_{j}^{down} ) {x}_{j , t} . \qquad ( 13 )$$

Allowed Change Windows: Furthermore, the fulfillment time of a change might be restricted to a number of allowed change window time slots, e.g., on weekends or during night times. Violating a change window restriction might have serious impact on the business, as that would mean a service is down in times this service is frequently needed. Therefore, penalties may result from exceeding a change window l (l=1, . . . , L). Let T_{cj} (T_{cj}={t_{cj1}^{start}, . . . , t_{cj1}^{end}}, . . . {t_{cjL}^{start}, . . . , t_{cjL}^{end}} be the set of allowed change windows. As change related downtime may be of uncertain length, there is an increasing risk of violating the change window constraints the later a change is started. With δ as the cost per time slot that a change window is exceeded, and the restriction that a change has to (at least) start inside a change window (tⱼεT_{cj}), the part that has to be added to the objective function as formulated in our decision model is:

$$min {\sum }_{t} max ( 0 , δ ( {t}_{j} + Δ {t}_{j}^{down} - min ( {t}_{jl}^{end} \text{:} {t}_{jl}^{end} > {t}_{j} ) ) ) {x}_{j , t} . \qquad ( 14 )$$

Correlated Changes: The basic model formulation handles multiple independent changes. To schedule changes in a mandatory order, a constraint for each dependency has to be added to the decision model formulation. Firstly, changes might need to be started in a certain sequence (tⱼ<tⱼ₊₁<tⱼ₊₂< . . . ) or a change must be fulfilled before the next change may get scheduled (tⱼ+Δtⱼ^{down}<tⱼ₊₁+Δtⱼ₊₁^{down}< . . . ). The constraints in the present mathematical model formulation are therefore xᵢₜ<x₍ⱼ₊₁₎ₜ<t₍ⱼ₊₂₎ₜ, or xⱼₜ+Δtⱼ^{down}<x₍ⱼ₊₁₎ₜ+Δtⱼ₊₁^{down}<tⱼ₊₂, respectively.

Besides mandatory change scheduling orders, changes may be correlated, for example, in terms of a reduction of aggregated downtime, when executing changes together (e.g., say two changes to a server operating system are needed, both requiring a reboot). The overall change duration may be reduced by applying these changes together, but this may result in higher risk in terms of higher downtime variance (incompatibilities, etc.). While arbitrary statistical values can be chosen, in the present example, we focus on mean (M) and variance (V) deviation. Therefore, we consider two changes to j and j+1 as correlated if either M(Δtⱼ^{down}(t)+Δtⱼ₊₁^{down}(t))≠M(Δtⱼ^{down}(t)+Δtⱼ₊₁^{down}(t+Δt)) and/or V(Δtⱼ^{down}(t)+Δtⱼ₊₁^{down}(t))≠V(Δtⱼ^{down}(t)+Δtⱼ₊₁^{down}(t+Δt)).

We treat each change item combination with significant deviant aggregated statistical mean and/or variance values as one single change. The decision to make is to either schedule all included single changes separately or to schedule the novel ‘aggregated’ change instead. This exclusive or (XOR) constraint can be formulated as follows (if the question is to change j and j+1 separately, or, alternatively the aggregated change (j, j+1)):

$${\sum }_{t} {x}_{j , t} + {x}_{( j + 1 ) , l} + 2 {x}_{( j , j + 1 ) , t} = 2. \qquad ( 15 )$$

Furthermore, the change deadline for (j, j+1) is set to min (t_{j,RFC}+Δtⱼ^{d}, t_{j+1,RFC}+Δtⱼ₊₁^{d}).

Change Re-Scheduling. The decision model selects the time slot with the lowest expected overall costs based on business process demand forecasting. However, when approaching tⱼ, further knowledge is available of process demand and process instances' states (progress). This knowledge can be used to reschedule the change start time tⱼ. For example, if in (tⱼ−1) more business process instances are running than expected, or a higher percentage of running instances is currently executing service j, there is a decision to make on whether to retain tⱼ or to wait several timeslots. However, increasing delay costs, and a higher probability of violating change window restrictions have to be taken into account when making such a decision. Note that demand forecasting for processes may be adapted by using short term prognoses if current demand differs significantly from demand expected beforehand. Furthermore, business process request arrivals may be modeled as a Poison Process to consider the uncertainty regarding the exact arrival rates, with P_{λ(i)} (r=k) as the probability of k incoming service i requests in t. As we did with downtime uncertainty, we model the impact of different possible arrival rates weighted by their probabilities.

Experimental Analysis: We analyze the efficiency of the scheduling models in accordance with the present principles. In preliminary experimental evaluations, we compared variants of the present models to optimal solutions (by scanning the total solution space), with total change related costs under different service infrastructures, demand scenarios, and downtime distributions used as benchmarks.

Experimental Set-Up: We analyzed 12 different service infrastructure scenarios under different business process demand profiles. The durations of each experiment was set to 300 time slots t (t=0, . . . , 299). The change deadline was set to tⱼ^{d}=275 with fixed costs if this restriction was violated and additional costs per exceeded times slot. In our first evaluations, change windows, and waiting costs were not considered. To allow for sensitivity analysis how variations in the output of our models can be apportioned to variations of j's downtime distribution, we repeated each experiment until our results were significant (referred to as experimental item, average over all outcomes) for each downtime distribution. We analyzed 8 different downtime distributions with increasing variance. To configure and automate our experiments and to analyze our experimental outcomes a simulation tool has been developed (see FIG. 5).

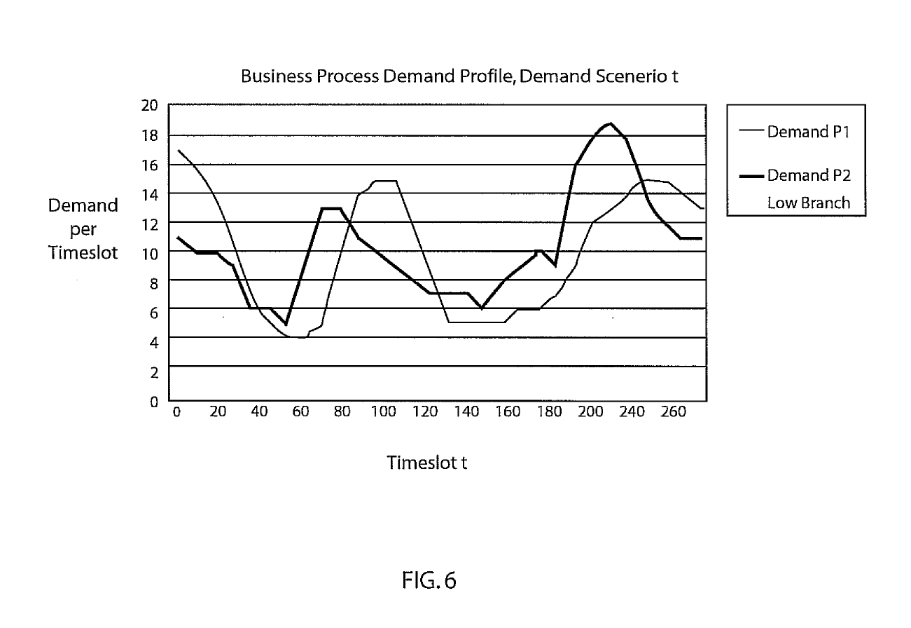

Referring to FIG. 5, a visualization 300 of an example service infrastructure scenario used in our experiments with two business processes, a linear process 302 and a forked process 304 is shown. An example business process demand scenario is shown in FIG. 6. The graph of FIG. 6 shows the mean demand level M per time slot. We adapted the demand level after each time slot to generate a demand profile following these curves. During a time slot, we generated demand following a (M, 0.20M) normal probability distribution (uniformly distributed).

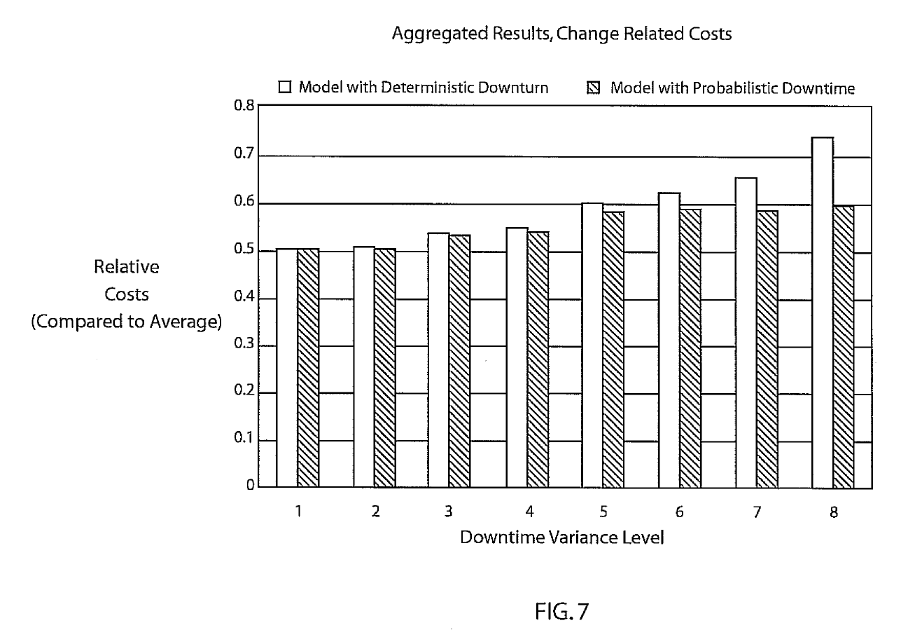

Experimental Results: Experimental results show that the probabilistic decision model with a simple resource of the service downtime distributions (applying the objective function as shown in equation (10)) found the optimal solution for all experimental items. In experiments with low service downtime variance (less than 15% of the mean downtime duration), the deterministic model selected the change start time slot with minimum costs. Except one demand scenario with almost flat process demand levels, the deterministic variant never found the optimal solution in scenarios with one of the two highest downtime variances. FIG. 7 presents aggregated results of the cost savings by using either the deterministic or the probabilistic scheduling model. The bars show the change related costs when using one of the two decision model variants relative to the average costs over all scenarios (with a certain downtime variance level) when the change start time was selected randomly.

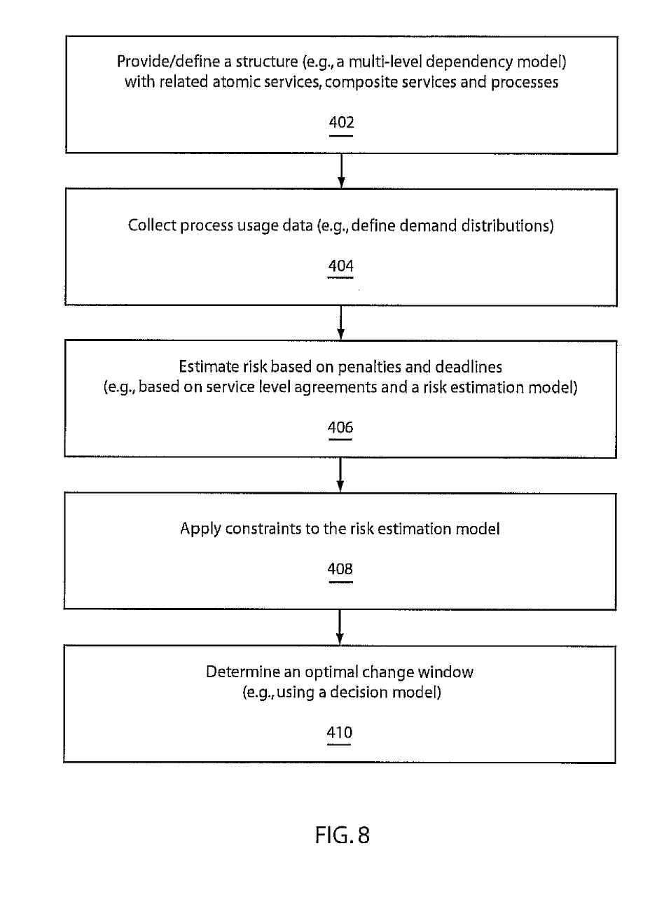

Referring to FIG. 8, a method for determining and managing risk impact under service downtime condition is illustratively shown. In block 402, a process structure is defined for one or more process types, services that the structure employs and a distribution of time durations of process steps. The structure may include a multi-layered dependency model which relates the processes with services such that services affected by a service's downtime. The structure is preferably a multi-layered dependency model which includes process definitions, composite service and atomic services and relationships therebetween. In block 404, process usage data is collected for each type of process. This may include defining a demand distribution (D) for each process and service to determine affects before and after a change.

In block 406, risk is estimated based on penalties and expected deadlines for each process. The penalties and expected deadlines are preferably based upon service level agreements. Compliance with service level agreement violations may be considered where queuing is permitted or not permitted. The risk estimation can consider non-linear service and process flows, e.g., by considering conditional branching of process flows. The risk may be estimated using a deterministic model or stochastic change scheduling model to minimize a total sum of penalties.

Constraints may be applied to introduce change related deadlines based upon one of a severity and a priority of a change in block 408.

In block 410, for a given change and outage of a service, an optimal change window is determined with respect to a minimized impact on the process based on the estimated risk. The optimal change window is determined by selecting time slots with a lowest expected cost based upon demand forecasting using a decision model.

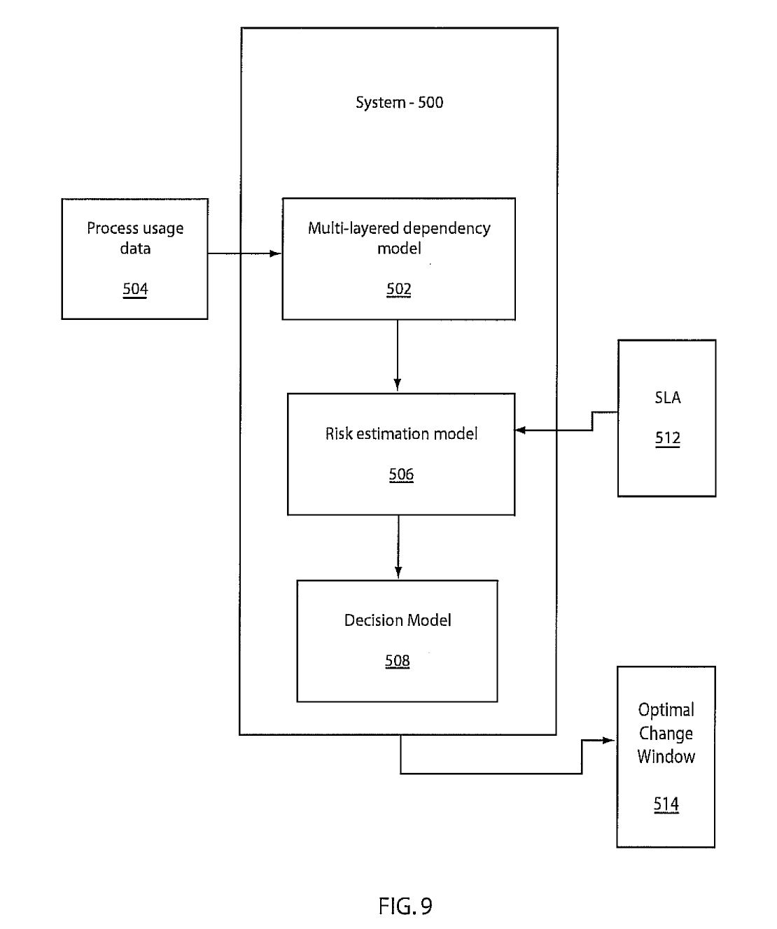

Referring to FIG. 9, a system 500 for determining risk impact for service downtime is illustratively depicted. A multi-layered dependency model 502 is configured to include process definitions, composite services and atomic services and relationships therebetween. The dependency model has a structure configured to define one or more process types, services the structure employs and a distribution of time durations of steps of each process. Process usage data 504 is stored for each type of process including a demand distribution for each process and service to determine affects before and after a change.

A risk estimation model 506 is configured to estimate risk by minimizing a total sum of penalties in accordance with expected deadlines for each process wherein the penalties and expected deadlines are based upon service level agreements (SLA) 512. A decision model 508 is configured to determine an optimal change window 514 for a given change and outage of a service, wherein the optimal change window provides a minimized impact on a process based on the estimated risk.

The models are provided to analyze the business impact of changes in a network of services. Change related operational risks on active business process instances and techniques are analyzed to relate these risks to financial metrics.

The present work is the first to formally quantify the risk of changing services in SOA environments to business (processes), or that derives decision models which allow organizations to schedule service changes with minimum total expected costs.

In our experimental analyses, we evaluated the efficiency of our models compared to the optimal and average solution, with total change related costs under different demand scenarios and downtime distributions used as a benchmark. We conducted preliminary numerical experiments with various business process demand scenarios and different downtime distributions and made initial efficiency statements. Experimental results show that the probabilistic model derived the optimal solution in all of our experiments.

Having described preferred embodiments of a system and method for automated decision support for service transition management (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for determining and managing risk impact of service downtime, comprising:
defining a process structure of one or more process types, services the process structure employs and a distribution of the services' time durations;
collecting process usage data for each type of process;
estimating risk based on penalties and expected deadlines for each process; and
for a service change and outage of a given length of time, determining an optimal change window with respect to a minimized impact on the process based on the estimated risk.

2. The method as recited in claim 1, wherein defining a process structure includes defining a multi-layered dependency model which relates processes with services such that services are affected by a service's downtime.

3. The method as recited in claim 1, wherein defining a structure includes defining a multi-layered dependency model which includes process definitions, composite service and atomic services and relationships therebetween.

4. The method as recited in claim 1, wherein collecting process usage data includes defining a demand distribution for each process and service to determine affects before and after a change.

5. The method as recited in claim 1, wherein estimating risk based on penalties and expected deadlines for each process includes defining penalties and expected deadlines based upon service level agreements.

6. The method as recited in claim 5, wherein estimating risk includes estimating risk by considering compliance of service level agreement violations where queuing is permitted.

7. The method as recited in claim 5, wherein estimating risk includes estimating risk by considering compliance of service level agreement violations where queuing is not permitted.

8. The method as recited in claim 1, wherein estimating risk based on penalties and expected deadlines for each process includes considering a cost of leaving a service unchanged.

9. The method as recited in claim 1, wherein estimating risk includes estimating risk by considering non-linear service and process flows.

10. The method as recited in claim 9, wherein estimating risk by considering non-linear service and process flows includes estimating risk by considering conditional branching of process flows.

11. The method as recited in claim 1, wherein estimating risk includes minimizing a total sum of penalties using a deterministic model.

12. The method as recited in claim 11, further comprising applying a constraint to introduce change related deadlines based upon at least one of severity and priority of a change.

13. The method as recited in claim 1, wherein estimating risk includes minimizing a total sum of penalties using a stochastic change scheduling model.

14. The method as recited in claim 1, wherein determining an optimal change window includes selecting time slots with a lowest expected cost based upon demand forecasting using a decision model.

15. A computer readable medium comprising a computer readable program for determining and managing risk impact of service downtime, wherein the computer readable program when executed on a computer causes the computer to perform the steps of:
defining a process structure of one or more process types, services the process structure employs and a distribution of the services' time durations;
collecting process usage data for each type of process;
estimating risk based on penalties and expected deadlines for each process; and
for a service change and outage of a given length of time, determining an optimal change window with respect to a minimized impact on the process based on the estimated risk.

16. The computer readable medium as recited in claim 15, wherein defining a structure includes defining a multi-layered dependency model which includes process definitions, composite service and atomic services and relationships therebetween.

17. The computer readable medium as recited in claim 15, wherein collecting process usage data includes defining a demand distribution for each process and service to determine affects before and after a change.

18. The computer readable medium as recited in claim 15, wherein estimating risk based on penalties and expected deadlines for each process includes defining penalties and expected deadlines based upon service level agreements.

19. The computer readable medium as recited in claim 18, wherein estimating risk includes at least one of: estimating risk by considering compliance of service level agreement violations where queuing is permitted; estimating risk by considering compliance of service level agreement violations where queuing is not permitted; and considering a cost of leaving a service unchanged.

20. The computer readable medium as recited in claim 15, wherein estimating risk includes estimating risk by considering non-linear service and process flows and estimating risk by considering conditional branching of process flows.

21. The computer readable medium as recited in claim 15, wherein estimating risk includes one of: minimizing a total sum of penalties using a deterministic model, and minimizing a total sum of penalties using a stochastic change scheduling model.

22. The computer readable medium as recited in claim 21, further comprising applying a constraint to introduce change related deadlines based upon at least one of severity and priority of a change.

23. The computer readable medium as recited in claim 15, wherein determining an optimal change window includes selecting time slots with a lowest expected cost based upon demand forecasting using a decision model.

24. A system for determining risk impact for service downtime, comprising:
a multi-layered dependency model configured to includes process definitions, composite services and atomic services and relationships therebetween, the dependency model having a structure configured to define one or more process types, services the structure employs and a distribution of time durations of steps of each process;
process usage data being stored for each type of process including a demand distribution for each process and service to determine affects before and after a change;
a risk estimation model configured to estimating risk by minimizing a total sum of penalties in accordance with expected deadlines for each process wherein the penalties and expected deadlines are based upon service level agreements; and
a decision model configured to determine an optimal change window for a given change and outage of a service, wherein the optimal change window provides a minimized impact on a process based on the estimated risk.

25. The system as recited in claim 24, wherein determining an optimal change window includes selecting time slots with a lowest expected cost based upon demand forecasting.
